(19) United States
(12) Patent Application Publication
(10) Pub. No.: US 2016/0335945 A1
(43) Pub. Date: Nov. 17, 2016

(54) LIQUID CRYSTAL PANEL AND DRIVING METHOD THEREOF

(71) Applicant: SHENZHEN CHINA STAR OPTOELECTRONICS TECHNOLOGY CO., LTD., Shenzhen, Guangdong (CN)

(72) Inventors: Chih-tsung KANG, Shenzhen, Guangdong (CN); Lixuan CHEN, Shenzhen, Guangdong (CN)

(73) Assignee: Shenzhen China Star Optoelectronics Technology Co., Ltd., Shenzhen, Guangdong (CN)

(21) Appl. No.: 14/426,743

(22) PCT Filed: Nov. 12, 2014
(86) PCT No.: PCT/CN2014/090948

§ 371 Date: Mar. 7, 2015

(30) Foreign Application Priority Data
Nov. 7, 2014 (CN) 201410624137.4

(51) Int. Cl. G09G 3/20; G09G 3/36

(52) U.S. Cl. CPC G09G 3/2074; G09G 3/3607; G09G 3/3674; G09G 3/3685; G09G 2320/0242; G09G 2320/0626; G09G 2300/0465; G09G 2300/0452; G09G 2320/0673; G09G 2320/0276

(57) ABSTRACT

A driving method of liquid crystal panel includes: providing a liquid crystal panel including multiple pixel units, each pixel unit at least including a green sub-pixel and a blue sub-pixel; dividing the liquid crystal panel into multiple display units, each display nit including neighboring first pixel unit and second pixel unit; and for grayscale values B and G of blue sub-pixel and green sub-pixel required by the display unit, dividing the grayscale values B and G respectively into a combination of grayscale values BH, BL and a combination of grayscale values GH, GL for the first and second pixel units, so that brightnesses of the blue sub-pixels and the green sub-pixels of the display unit at an oblique viewing angle are approximate to a predetermined Gamma(γ) curve. γ=1.8˜2.4. Moreover, a liquid crystal panel being driven by the above driving method also is provided.

### TECHNICAL FIELD

The present invention relates to the field of liquid crystal display technology, and particularly to a liquid crystal panel and a driving method thereof.

### DESCRIPTION OF RELATED ART

A liquid crystal display (LCD) device is one type of ultra-thin flat display device and constituted by a certain amount of color or monochrome pixels disposed on front of a light source or a reflective plate. The liquid crystal display device has the advantages of low power consumption, high quality image, small size and light weight, and therefore wins the favor of people and has become the mainstream of display device. The liquid crystal display device has been widely used in various electronic products, such as computer equipments with display screen, mobile phones, or digital photo frames and so on, and a wide viewing angle technology is one of current important development trends for the liquid crystal display device. However, when a side viewing angle or an oblique viewing angle is excessively large, the wide viewing angle liquid crystal display device usually generates the color shift phenomenon.

For the color shift problem of the wide viewing angle liquid crystal display device, a 2D1G technology currently has been proposed in the industry for improvement. The so-called 2D1G technology is that each pixel unit in a liquid crystal panel is divided into a main pixel area and a sub pixel area with different areas, and the main pixel area and the sub pixel area in a same pixel unit are connected to different data lines but a same gate line. By inputting different data signals (different grayscale values) to the main pixel area and the sub pixel area to generate different display brightnesses and oblique viewing brightnesses, the color shift problem occurs when side viewing or oblique viewing can be reduced. However, for each pixel unit, after being divided into the main pixel area and the sub pixel area, the amount/number of data lines for inputting data signals are doubled, which would greatly reduce the aperture ratio of the liquid crystal panel, affect the transmittance and degrade the display quality of the liquid crystal panel.

### SUMMARY

Accordingly, an objective of the invention is to provide a liquid crystal panel and a driving method thereof, by changing a driving method of liquid crystal panel and simulating a display of 2D1G panel in a traditional RGB three-pixel liquid crystal panel, so as to achieve the purpose of reducing the color shift problem occurs when side viewing or oblique viewing.

In order to achieve the above objective, the invention provides the following technical solution.

Specifically, a driving method of liquid crystal panel includes: providing a liquid crystal panel, wherein the liquid crystal panel includes multiple (i.e., more than one) pixel units, and each pixel unit at least includes a green sub-pixel and a blue sub-pixel; dividing the liquid crystal panel into multiple display units, wherein each display unit includes neighboring first pixel unit and second pixel unit of the pixel units; for a grayscale value B of blue sub-pixel required by the display unit, providing the blue sub-pixel of the first pixel unit with a grayscale value BH and providing the blue sub-pixel of the second pixel unit with a grayscale value BL, wherein the grayscale values BH and BL constitute a combination which makes a brightness of the blue sub-pixels of the display unit at an oblique viewing angle be approximate to a predetermined Gamma (γ) curve; and for a grayscale value G of green sub-pixel required by the display unit, providing the green sub-pixel of the first pixel unit with a grayscale value GH and providing the green sub-pixel of the second pixel unit with a grayscale value GL, wherein the grayscale values GH and GL constitute a combination which makes a brightness of the green sub-pixels of the display unit at the oblique viewing angle be approximate to the predetermined Gamma (γ) curve, and γ=1.8˜2.4.

In an exemplary embodiment, the required grayscale value B is achieved by providing the combination of the grayscale values BH and BL, which concretely includes steps:

S101, obtaining a relation curve B₀−LvαB₀ between actual brightnesses and grayscale values of the blue sub-pixels of the liquid crystal panel at a front viewing angle α;

S102, obtaining a relation curve B₀−LvβB₀ between actual brightnesses and grayscale values of the blue sub-pixels of the liquid crystal panel at an oblique viewing angle β;

S103, obtaining relation curves B−LvαB and B−LvβB between theoretical brightnesses and grayscale values of the blue sub-pixels of the liquid crystal panel at the front viewing angle α and the oblique viewing angle β respectively by calculation according to a formula of

$${( \frac{B}{255} )}^{γ} = \frac{LvB}{Lv ( 255 )} ;$$

S104, for the grayscale value B of blue sub-pixel of the display unit, the grayscale value BH provided to the blue sub-pixel of the first pixel unit and the grayscale value BL provided to the blue sub-pixel of the second pixel unit satisfying the following relational expressions:

Δ1=LvαB+LvαB−Lvα(BH)−Lvα(BL);

Δ2=LvβB+LvβB−Lvβ(BH)−Lvβ(BL);

y1=Δ1²+Δ2²;

where y1 takes a minimum value, values of LvαB and LvβB are obtained by lookup from the relation curves B−LvαB and B−LvβB, values of Lvα(BH) and Lvα(BL) are obtained by lookup from the relation curve B₀−LvαB₀, and values of Lvβ(BH) and Lvβ(BL) are obtained by lookup from the relation curve B₀−LvβB₀;

S105, for each grayscale value B of blue sub-pixel required by the display unit, obtaining a corresponding combination of grayscale values BH and BL according to the step S104 and thereby re-building a display lookup table for the blue sub-pixels of the liquid crystal panel.

In an exemplary embodiment, the required grayscale value G is achieved by providing the combination of the grayscale values GH and GL, which concretely includes steps:

S201, obtaining a relation curve G₀−LvαG₀ between actual brightnesses and grayscale values of the green sub-pixels of the liquid crystal panel at the front viewing angle α;

S202, obtaining a relation curve G₀−LvβG₀ between actual brightnesses and grayscale values of the green sub-pixels of the liquid crystal panel at the oblique viewing angle β;

S203, obtaining relation curves G−LvαG and G−LvβG between theoretical brightnesses and grayscale values of the green sub-pixels of the liquid crystal panel at the front viewing angle α and the oblique viewing angle β respectively by calculation according to a formula of

$${( \frac{G}{255} )}^{γ} = \frac{LvG}{Lv ( 255 )} ;$$

S204, for the grayscale value G of green sub-pixel required by the display unit, the grayscale value GH provided to the green sub-pixel of the first pixel unit and the grayscale value GL provided to the green sub-pixel of the second pixel unit satisfying the following relational expressions:

Δ1=LvαG+LvαG−Lvα(GH)−Lvα(GL);

Δ2=LvβG+LvβG−Lvβ(GH)−Lvβ(GL);

y2=Δ1²+Δ2²;

where y2 takes a minimum value, values of LvαG and LvβG are obtained by lookup from the relation curves G−LvαG and G−LvβG, values of Lvα(GH) and Lvα(GL) are obtained by lookup from the relation curve G₀−LvαG₀, and values of Lvβ(GH) and Lvβ(GL) are obtained by lookup from the relation curve G₀-LvβG₀;

S205, for each grayscale value G of green sub-pixel required by the display unit, obtaining a corresponding combination of grayscale values GH and GL according to the step 204 and thereby re-building a display lookup table for the green sub-pixels of the liquid crystal panel.

In an exemplary embodiment, the front viewing angle α is 0°, and the oblique viewing angle β is 30°˜80°.

In an exemplary embodiment, the oblique viewing angle β is 60°.

In an exemplary embodiment, each pixel unit further includes a red sub-pixel, and a data signal for the red sub-pixel remains unchanged when re-setting data parameters for the blue sub-pixel and the green sub-pixel.

In an exemplary embodiment, the liquid crystal panel further includes a gate controller and a source controller; the gate controller is configured (i.e., structured and arranged) for providing scan signals to the pixel units through multiple scan lines, and the source controller is configured for providing data signals to the pixel units through multiple data lines.

In an exemplary embodiment, grayscales of the liquid crystal panel includes 256 levels of 0˜255.

In an exemplary embodiment, in the predetermined Gamma (γ) curve, γ=2.2.

Another aspect of the invention provides a liquid crystal panel. The liquid crystal panel includes a gate controller, a source controller and pixel units. Each pixel unit at least includes a blue sub-pixel and a green sub-pixel. The gate controller is configured for providing scan signals to the pixel units through multiple scan lines. The source controller is configured for providing data signals to the pixel units through multiple data lines. A driving method of the liquid crystal panel uses the above described driving method.

The efficacy of the invention is that: the liquid crystal panel and the driving method thereof provided by the invention, by changing the driving method of a traditional RGB three-pixel liquid crystal panel to simulate a display of 2D1G panel, so as to reduce the color shift problem occurs when side viewing or oblique viewing, and meanwhile the aperture ratio of the liquid crystal panel is not reduced and thus the display quality of the liquid crystal panel is ensured.

### BRIEF DESCRIPTION OF THE DRAWINGS

The above and other aspects, features and advantages of embodiments of the invention will be more apparent from the following detailed description taken in conjunction with the accompanying drawings, in which:

FIG. 1 is a schematic structural view of a liquid crystal panel provided by an embodiment of the invention;

FIG. 2 is a schematic view of dividing display units in a liquid crystal panel provided by an embodiment of the invention;

FIG. 3 is a schematic view of supplying data signals to a display unit in a driving method provided by an embodiment of the invention; and

FIG. 4 is an actual brightness graph of a blue sub-pixel and a green sub-pixel in a liquid crystal panel at a front viewing angle and at an oblique viewing angle, provided in an embodiment of the invention.

### DETAILED DESCRIPTION OF EMBODIMENTS

In order to make the objectives, technical solutions and advantages of the invention that will be more clearly understood, the invention is further described by using various embodiments with reference to accompanying drawings.

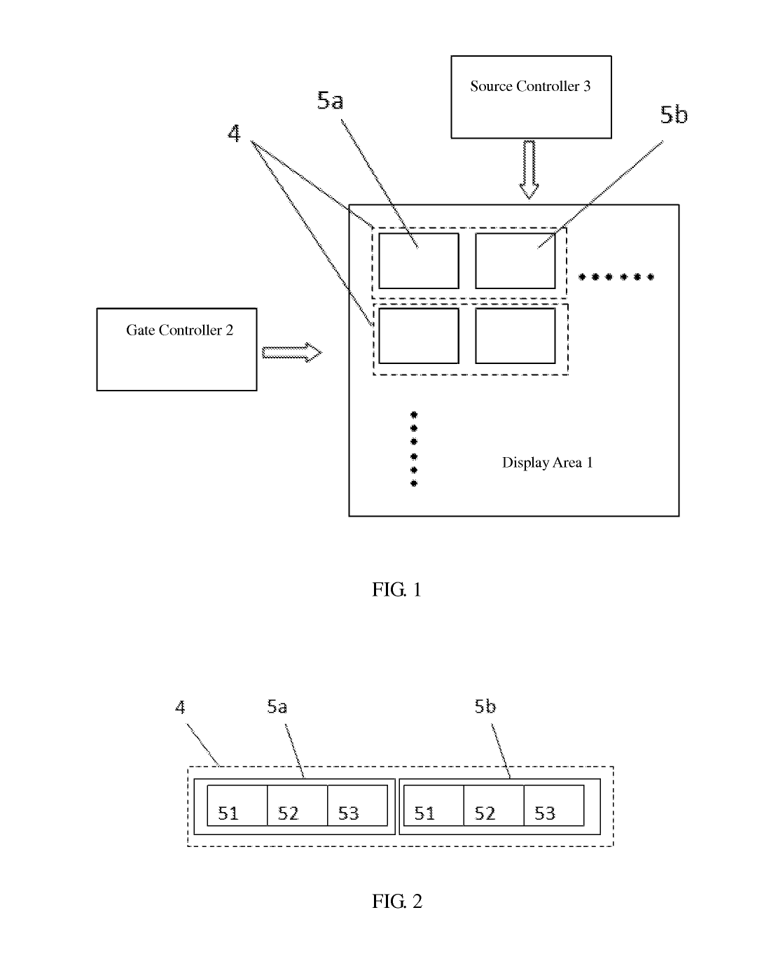

Referring to FIG. 1, a traditional liquid crystal panel mainly include a display area 1 with multiple (i.e., more than one) pixel units 5a, 5b, a gate controller 2 and a source controller 3. The gate controller 2 is configured (i.e., structured and arranged) for supplying scan signals to the pixel units 5a, 5b through multiple scan lines. The source controller 3 is configured for supplying data signals to the pixel units 5a, 5b through multiple data lines. Each of the pixel units 5a, 5b includes a red sub-pixel 51, a green sub-pixel 52 and a blue sub-pixel 53.

An objective of this embodiment is to change a driving method of a liquid crystal panel, for example to simulate a display of 2D1G panel in the traditional RGB three-pixel liquid crystal panel, so as to achieve the purpose of reducing the color shift problem occurs when side viewing or oblique viewing.

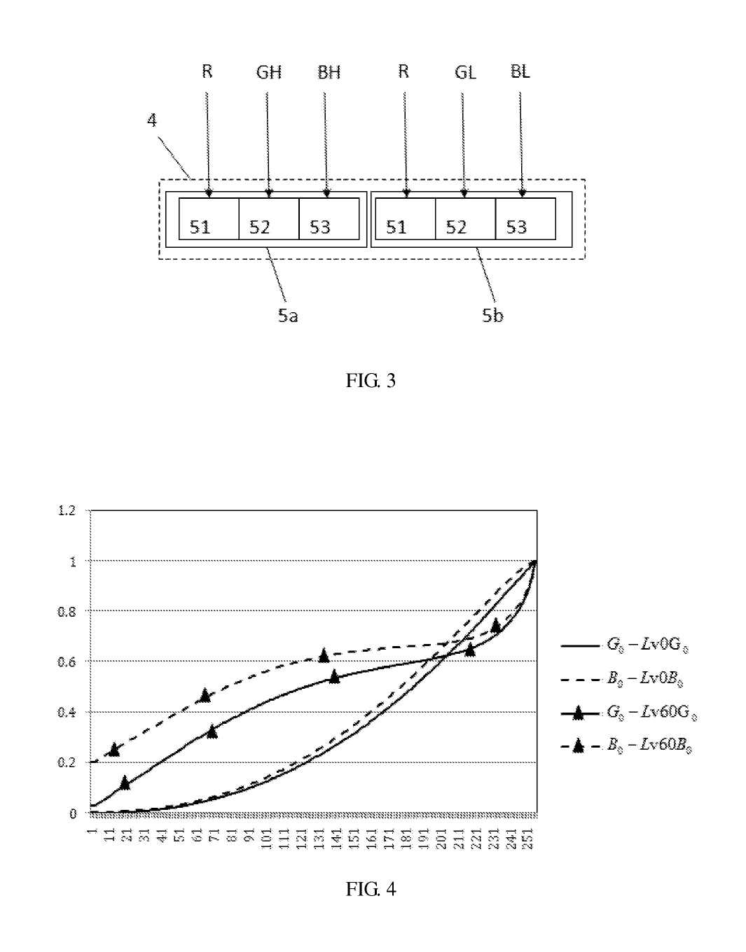

Accordingly, as shown in FIG. 1 and FIG. 2, firstly, the liquid crystal panel 1 is divided into multiple display units 4, and each display unit 4 includes neighboring first pixel unit 5a and second pixel unit 5b. When driving the liquid crystal panel, for a grayscale value B of blue sub-pixel 53 required by the display unit 4, the blue sub-pixel 53 in the first pixel unit 5a is provided with a grayscale value BH, the blue sub-pixel 53 in the second pixel unit 5b is provided with a grayscale value BL, and the combination of the grayscale values BH and BL makes a brightness of the blue sub-pixels 53 of the display unit 4 at an oblique viewing angle be approximate to a predetermined Gamma (γ) curve. For a grayscale value G of green sub-pixel 52 required by the display unit 4, the green sub-pixel 52 in the first pixel unit 5a is provided with a grayscale value GH, the green sub-pixel 52 in the second pixel unit 5b is provided with a grayscale value GL, and the combination of the grayscale values GH and GL makes a brightness of the green sub-pixels 52 of the display unit 4 at the oblique viewing angle approximate to the predetermined Gamma (γ) curve. The Gamma (γ) curve is determined by requirement of actual liquid crystal panel, and a value of γ may be in the range of 1.8˜2.4. FIG. 3 is an exemplary illustration of inputting data signals to the display unit 4. As shown in FIG. 3, for the two pixel units 5a, 5b of the display unit 4, when re-setting the data parameters BH, BL for the blue sub-pixels 53 and the data parameters GH, GL for the green sub-pixels 52, the data signals R for the red sub-pixels 51 remain unchanged.

In an exemplary embodiment, a front viewing angle α is 0°, and a range of the oblique viewing angle β is 30°˜80°.

As exemplarily illustrated in FIGS. 1 through 3:

(1) dividing a grayscale value B into a combination of grayscale values BH and BL concretely includes:

S101, obtaining a relation curve B₀−LvαB₀ between actual brightnesses and grayscales of the blue sub-pixels 53 of the liquid crystal panel at the front viewing angle α.

S102, obtaining a relation curve B₀−LvβB₀ between actual brightnesses and grayscales of the blue sub-pixels 53 of the liquid crystal panel at the oblique viewing angle β.

S103, obtaining relation curves B-LvαB and B-LvβB between theoretical brightnesses and grayscales of the blue sub-pixels 53 of the liquid crystal panel respectively at the front viewing angle α and the oblique viewing angle β by calculation according to a formula of

$${( \frac{B}{255} )}^{γ} = \frac{LvB}{Lv ( 255 )} .$$

S104, for the grayscale value B of blue sub-pixel 53 required by the display unit 4, the grayscale value BH provided to the blue sub-pixel 53 of the first pixel unit 5a and the grayscale value BL provided to the blue sub-pixel 53 of the second pixel unit 5b satisfying the following relational expressions:

Δ1=LvαB+LvαB−Lvα(BH)−Lvα(BL);

Δ2=LvβB+LvβB−Lvβ(BH)−Lvβ(BL);

y1=Δ1²+Δ2²;

where, y1 takes the minimum value, values of LvαB and LvβB are obtained by lookup from the relation curves B-LvαB and B-LvβB, values of Lvα(BH) and Lvα(BL) are obtained by lookup from the relation curve B₀-LvαB₀, values of Lvβ(BH) and Lvβ(BL) are obtained by lookup from the relation curve B₀-LvβB₀.

S105, for each grayscale value B of blue sub-pixel 53 required by the display unit 4, obtaining a corresponding combination of grayscale values BH and BL according to the step S104, and thereby re-building a display lookup table (LUT) for the blue sub-pixels 53 of the liquid crystal panel.

(2) dividing a grayscale value B into a combination of grayscale values GH and GL concretely includes:

S201, obtaining a relation curve G₀-LvαG₀ between actual brightnesses and grayscales of the green sub-pixels 52 of the liquid crystal panel at the front viewing angle α.

S202, obtaining a relation curve G₀-LvβG₀ between actual brightnesses and grayscales of the green sub-pixels 52 of the liquid crystal panel at the oblique viewing angle β.

S203, obtaining relation curves G-LvαG and G-LvβG between theoretical brightnesses and grayscales of the green sub-pixels 52 of the liquid crystal panel respectively at the front viewing angle α and the oblique viewing angle β by calculation according to a formula of

$${( \frac{G}{255} )}^{γ} = \frac{LvG}{Lv ( 255 )} .$$

S204, for the grayscale value G of green sub-pixel 52 required by the display unit 4, the grayscale value GH provided to the green sub-pixel 52 of the first pixel unit 5a and the grayscale value GL provided to the green sub-pixel 52 of the second pixel unit 5b satisfying the following relational expressions:

Δ1=LvαG+LvαG−Lvα(GH)−Lvα(GL);

Δ2=LvβG+LvβG−Lvβ(GH)−Lvβ(GL);

y2=Δ1²+Δ2²;

where, y2 takes the minimum value, values of LvαG and LvβG are obtained by lookup from the relation curves G−LvαG and G−LvβG, values of Lvα(GH) and Lvα(GL) are obtained by lookup from the relation curve G₀−LvαG₀, values of Lvβ(GH) and Lvβ(GL) are obtained by lookup from the relation curve G₀−LvβG₀.

S205, for each grayscale value G of blue sub-pixel 52 required by the display unit 4, obtaining a corresponding combination of grayscale values GH and GL according to the step S204, and thereby re-building a display lookup table (LUT) for the green sub-pixels 52 of the liquid crystal panel.

In the following, a concrete example that γ=2.2 in the predetermined Gamma (γ) curve, the front viewing angle α=0° and the oblique viewing angle β=60° is taken to explain a concrete process of dividing the grayscale value B into the combination of the grayscale values BH and BL and dividing the grayscale value G into the combination of the grayscale values GH and GL in detail.

Firstly, obtaining relation curves B₀−Lv0B₀ and G₀−Lv0G₀ between actual brightnesses and grayscales of blue sub-pixels 53 and green sub-pixels 52 respectively of the liquid crystal panel at the front viewing angle α=0°, and obtaining relation curves B₀−Lv60B₀ and G₀−Lv60G₀ between actual brightnesses and grayscales of blue sub-pixels 53 and green sub-pixels 52 respectively of the liquid crystal panel at the oblique viewing angle β=60°, please refer to the relation curves as shown in FIG. 4. The liquid crystal panel includes 256 levels of grayscale, i.e., generally 0˜255.

After that, obtaining relation curves B−Lv0B and B−Lv60B between theoretical brightnesses and grayscales of the blue sub-pixels 53 of the liquid crystal panel respectively at the front viewing angle α=0° and the oblique viewing angle β=60° by calculation according to the formula

$${( \frac{B}{255} )}^{γ} = \frac{LvB}{Lv ( 255 )} .$$

In the foregoing formula, for the front viewing angle α=0°, Lv(255) is a brightness value in the curve B₀−Lv0B₀ corresponding to B₀=255, and for the oblique viewing angle β=60°, Lv(255) is a brightness value in the curve B₀−Lv60B₀ corresponding to B₀=255. Moreover, obtaining relation curves G−Lv0G and G−Lv60G between theoretical brightnesses and grayscales of the green sub-pixels 52 of the liquid crystal panel respectively at the front viewing angle α=0° and the oblique viewing angle β=60° by calculation according to the formula

$${( \frac{G}{255} )}^{γ} = \frac{LvG}{Lv ( 255 )} .$$

In the foregoing formula, for the front viewing angle α=0°, Lv(255) is a brightness value in the curve G₀−Lv0G₀ corresponding to G₀=255, and for the oblique viewing angle β=60°, Lv(255) is a brightness value in the curve G₀−Lv60G₀ corresponding to G₀=255.

Furthermore:

(1) if the grayscale value B of blue sub-pixel 53 required by the display unit 4 (i.e., grayscale values originally required to input to the blue sub-pixels 53 of the first pixel unit 5a and the second pixel unit 5b both are B), as a replacement of the grayscale value B, the grayscale value BH inputted to the blue sub-pixel 53 of the first pixel unit 5a and the grayscale value BL inputted to the blue sub-pixel 53 of the second pixel unit 5b satisfy the following relational expressions:

Δ1=Lv0B+Lv0B−Lv0(BH)−Lv0(BL);

Δ2=Lv60B+Lv60B−Lv60(BH)−Lv60(BL);

y=Δ1²+Δ2²;

when determining the required grayscale value B of blue sub-pixels 53, lookups the theoretical brightness curves B−Lv0B and B−Lv60B to obtain the values of Lv0B and Lv60B; at this time, lookups Lv0(BH) and Lv0(BL) from the actual brightness curve B₀−Lv0B₀ and lookups Lv60(BH) and Lv60(BL) from the actual brightness curve B₀−Lv60B₀ to make the value of y1 in the above relational expressions to be the minimum value, and thereby corresponding grayscale values BH and BL are obtained.

(2) if the grayscale value G of green sub-pixel 52 required by the display unit 4 (i.e., grayscale values originally required to input to the green sub-pixels 52 of the first pixel unit 5a and the second pixel unit 5b both are G), as a replacement of the grayscale value G, the grayscale value GH inputted to the green sub-pixel 52 of the first pixel unit 5a and the grayscale value GL inputted to the blue sub-pixel 52 of the second pixel unit 5b satisfy the following relational expressions:

Δ1=Lv0G+Lv0G−Lv0(GH)−Lv0(GL);

Δ2=Lv60G+Lv60G−Lv60(GH)−Lv60(GL);

y2=Δ1²+Δ2²;

when determining the required grayscale value G of green sub-pixel 52, lookups the theoretical brightness curves G−Lv0G and G−Lv60G to obtain the values of Lv0G and Lv60G; at this time, lookups Lv0(GH) and Lv0(GL) from the actual brightness curve B₀−Lv0B₀ and lookups Lv60(GH) and Lv60(GL) from the actual brightness curve G₀−Lv60G₀ to make the value of y2 in the above relational expressions to be the minimum value, and thereby corresponding grayscale values GH and GL are obtained.

Finally, for each grayscale value B of blue sub-pixel 53 required by the display unit 4, a corresponding combination of BH and BL is obtained according to the foregoing calculation method and then re-builds a display lookup table (LUT) for the blue sub-pixels 53 of the liquid crystal panel. For each grayscale value G of green sub-pixel 52 required by the display unit 4, a corresponding combination of GH and GL is obtained according to the foregoing calculation method and then re-builds a display lookup table (LUT) for the green sub-pixels 52 of the liquid crystal panel. When driving the liquid crystal panel to display an image, if the grayscale value of blue sub-pixel 53 required by the display unit 4 is B, determines the grayscale value BH provided to the blue sub-pixel 53 of the first pixel unit 5a and the grayscale value BL provided to the blue sub-pixel 53 of the second pixel unit 5b from the display lookup table; and if the grayscale value of green sub-pixel 52 required by the display unit 4 is G, determines the grayscale value GH provided to the green sub-pixel 52 of the first pixel unit 5a and the grayscale value GL provided to the green sub-pixel 52 of the second pixel unit 5b from the display lookup table.

For the liquid crystal panel and the driving method thereof in the above described embodiments, firstly, the traditional liquid crystal panel is divided into display units and each display unit includes two neighboring pixel units, corresponding to the grayscale B of blue sub-pixel required by the display unit, the blue sub-pixel of one pixel unit is provided with the grayscale value BH, and the blue sub-pixel of the other one pixel unit is provided with the grayscale value BL; corresponding to the grayscale G of green sub-pixel required by the display unit, the green sub-pixel of one pixel unit is provided with the grayscale value GH, and the green sub-pixel of the other one pixel unit is provided with the grayscale value GL. By way of the above method, the display effect of 2D1G panel can be achieved, the color shift problem occurs when side viewing or oblique viewing is reduced, and meanwhile the aperture ratio of the liquid crystal panel is not reduced and therefore the display quality of the liquid crystal panel is ensured.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A driving method of liquid crystal panel, comprising:
providing a liquid crystal panel, wherein the liquid crystal panel comprises a plurality of pixel units, and each of the plurality of pixel units at least comprises a green sub-pixel and a blue sub-pixel;
dividing the liquid crystal panel into a plurality of display units, wherein each of the plurality of display units comprises neighboring first pixel unit and second pixel unit of the plurality of pixel units;
for a grayscale value B of blue sub-pixel required by the display unit, providing the blue sub-pixel of the first pixel unit with a grayscale value BH and providing the blue sub-pixel of the second pixel unit with a grayscale value BL; wherein the grayscale values BH and BL constitute a combination which makes a brightness of the blue sub-pixels of the display unit at an oblique viewing angle be approximate to a predetermined Gamma (γ) curve;
for a grayscale value G of green sub-pixel required by the display unit, providing the green sub-pixel of the first pixel unit with a grayscale value GH and providing the green sub-pixel of the second pixel unit with a grayscale value GL; wherein the grayscale values GH and GL constitute a combination which makes a brightness of the green sub-pixels of the display unit at the oblique viewing angle be approximate to the predetermined Gamma (γ) curve, and γ=1.8˜2.4.

2. The driving method according to claim 1, wherein the required grayscale value B is achieved by providing the combination of the grayscale values BH and BL, which comprises steps:
S101, obtaining a relation curve β₀−LvαB₀ between actual brightnesses and grayscale values of the blue sub-pixels of the liquid crystal panel at a front viewing angle α;
S102, obtaining a relation curve B₀−LvβB₀ between actual brightnesses and grayscale values of the blue sub-pixels of the liquid crystal panel at an oblique viewing angle β;
S103, obtaining relation curves B−LvαB and B−LvβB between theoretical brightnesses and grayscale values of the blue sub-pixels of the liquid crystal panel at the front viewing angle α and the oblique viewing angle β respectively by calculation according to a formula of
$${( \frac{B}{255} )}^{γ} = \frac{LvB}{Lv ( 255 )} ;$$
S104, for the grayscale value B of blue sub-pixel required by the display unit, the grayscale value BH provided to the blue sub-pixel of the first pixel unit and the grayscale value BL provided to the blue sub-pixel of the second pixel unit satisfying the following relational expressions:
Δ1=LvαB+LvαB−Lvα(BH)−Lvα(BL);
Δ2=LvβB+LvβB−Lvβ(BH)−Lvβ(BL);
y1=Δ1²+Δ2²;
where y1 takes a minimum value, values of LvαB and LvβB are obtained by lookup from the relation curves B−LvαB and B−LvβB, values of Lvα(BH) and Lvα(BL) are obtained by lookup from the relation curve B₀−LvαB₀, and values of Lvβ(BH) and Lvβ(BL) are obtained by lookup from the relation curve B₀−LvβB₀;
S105, for each grayscale value B of blue sub-pixel required by the display unit, obtaining a corresponding combination of grayscale values BH and BL according to the step S104 and thereby re-building a display lookup table for the blue sub-pixels of the liquid crystal panel.

3. The driving method according to claim 2, wherein the required grayscale value G is achieved by providing the combination of the grayscale values GH and GL, which comprises steps:
S201, obtaining a relation curve G₀−LvαG₀ between actual brightnesses and grayscale values of the green sub-pixels of the liquid crystal panel at the front viewing angle α;
S202, obtaining a relation curve G₀−LvβG₀ between actual brightnesses and grayscale values of the green sub-pixels of the liquid crystal panel at the oblique viewing angle β;
S203, obtaining relation curves G−LvαG and G−LvβG between theoretical brightnesses and grayscale values of the green sub-pixels of the liquid crystal panel at the front viewing angle α and the oblique viewing angle β respectively by calculation according to a formula of
$${( \frac{G}{255} )}^{γ} = \frac{LvG}{Lv ( 255 )} ;$$
S204, for the grayscale value G of green sub-pixel required by the display unit, the grayscale value GH provided to the green sub-pixel of the first pixel unit and the grayscale value GL provided to the green sub-pixel of the second pixel unit satisfying the following relational expressions:
Δ1=LvαG+LvαG−Lvα(GH)−Lvα(GL);
Δ2=LvβG+LvβG−Lvβ(GH)−Lvβ(GL);
y2=Δ1²+Δ2²;
where y2 takes a minimum value, values of LvαG and LvβG are obtained by lookup from the relation curves G−LvαG and G−LvβG, values of Lvα(GH) and Lvα(GL) are obtained by lookup from the relation curve G₀−LvαG₀, and values of Lvβ(GH) and Lvβ(GL) are obtained by lookup from the relation curve G₀−LvβG₀;
S205, for each grayscale value G of green sub-pixel required by the display unit, obtaining a corresponding combination of grayscale values GH and GL according to the step S204 and thereby re-building a display lookup table for the green sub-pixels of the liquid crystal panel.

4. The driving method according to claim 3, wherein the front viewing angle α is 0°, and the oblique viewing angle β is 30°˜80°.

5. The driving method according to claim 4, wherein the oblique viewing angle β is 60°.

6. The driving method according to claim 1, wherein each of the plurality of pixel units further comprises a red sub-pixel, and a data signal for the red sub-pixel remains unchanged when re-setting data parameters for the blue sub-pixel and the green sub-pixel.

7. The driving method according to claim 1, wherein the liquid crystal panel further comprises a gate controller and a source controller; the gate controller is configured for providing scan signals to the plurality of pixel units through a plurality of scan lines, and the source controller is configured for providing data signals to the plurality of pixel units through a plurality of data lines.

8. The driving method according to claim 1, wherein grayscales of the liquid crystal panel comprises 256 levels of 0˜255.

9. The driving method according to claim 1, wherein in the predetermined Gamma (γ) curve, γ=2.2.

10. The driving method according to claim 3, wherein in the predetermined Gamma (γ) curve, γ=2.2.

11. A liquid crystal panel comprising a gate controller, a source controller and a plurality of pixel units; each of the plurality of pixel units at least comprising a blue sub-pixel and a green sub-pixel, the gate controller being configured for providing scan signals to the plurality of pixel units through a plurality of scan lines, the source controller being configured for providing data signals to the plurality of pixel units through a plurality of data lines; a driving method of the liquid crystal panel comprising:
dividing the liquid crystal panel into a plurality of display units, wherein each of the plurality of display units comprises a first pixel unit and a second pixel unit neighboring with each other;
for a grayscale value B of blue sub-pixel required by the display unit, providing the blue sub-pixel of the first pixel unit with a grayscale value BH and providing the blue sub-pixel of the second pixel unit with a grayscale value BL, wherein the combination of the grayscale values BH and BL makes a brightness of the blue sub-pixels of the display unit at an oblique viewing angle be approximate to a predetermined Gamma (γ) curve;
for a grayscale value G of green sub-pixel required by the display unit, providing the green sub-pixel of the first pixel unit with a grayscale value GH and providing the green sub-pixel of the second pixel unit with a grayscale value GL, wherein the combination of the grayscale values GH and GL makes a brightness of the green sub-pixels of the display unit at the oblique viewing angle be approximate to the predetermined Gamma (γ) curve, and γ=1.8˜2.4.

12. The liquid crystal panel according to claim 11, wherein the required grayscale value B is achieved by providing the combination of the grayscale values BH and BL, which comprises steps:
S101, obtaining a relation curve B₀−LvαB₀ between actual brightnesses and grayscale values of the blue sub-pixels of the liquid crystal panel at a front viewing angle α;
S102, obtaining a relation curve B₀−LvβB₀ between actual brightnesses and grayscale values of the blue sub-pixels of the liquid crystal panel at an oblique viewing angle β;
S103, obtaining relation curves B−LvαB and B−LvβB between theoretical brightnesses and grayscale values of the blue sub-pixels of the liquid crystal panel at the front viewing angle α and the oblique viewing angle β respectively by calculation according to a formula of
$${( \frac{B}{255} )}^{γ} = \frac{LvB}{Lv ( 255 )} ;$$
S104, for the grayscale value B of blue sub-pixel of the display unit, the grayscale value BH provided to the blue sub-pixel of the first pixel unit and the grayscale value BL provided to the blue sub-pixel of the second pixel unit satisfying the following relational expressions:
Δ1=LvαB+LvαB−Lvα(BH)−Lvα(BL);
Δ2=LvβB+LvβB−Lvβ(BH)−Lvβ(BL);
y1=Δ1²+Δ2²;
where y1 takes a minimum value, values of LvαB and LvβB are obtained by lookup from the relation curves B−LvαB and B−LvβB, values of Lvα(BH) and Lvα(BL) are obtained by lookup from the relation curve B₀−LvαB₀, and values of Lvβ(BH) and Lvβ(BL) are obtained by lookup from the relation curve B₀−LvβB₀;
S105, for each grayscale value B of blue sub-pixel required by the display unit, obtaining a corresponding combination of grayscale values BH and BL according to the step S104 and thereby re-building a display lookup table for the blue sub-pixels of the liquid crystal panel.

13. The liquid crystal panel according to claim 12, wherein the required grayscale value G is achieved by providing the combination of the grayscale values GH and GL, which comprises steps:
S201, obtaining a relation curve G₀−LvαG₀ between actual brightnesses and grayscale values of the green sub-pixels of the liquid crystal panel at the front viewing angle α;
S202, obtaining a relation curve G₀−LvβG₀ between actual brightnesses and grayscale values of the green sub-pixels of the liquid crystal panel at the oblique viewing angle β;
S203, obtaining relation curves G−LvαG and G−LvβG between theoretical brightnesses and grayscale values of the green sub-pixels of the liquid crystal panel at the front viewing angle α and the oblique viewing angle β respectively by calculation according to a formula of
$${( \frac{G}{255} )}^{γ} = \frac{LvG}{Lv ( 255 )} ;$$
S204, for the grayscale value G of green sub-pixel required by the display unit, the grayscale value GH provided to the green sub-pixel of the first pixel unit and the grayscale value GL provided to the green sub-pixel of the second pixel unit satisfying the following relational expressions:
Δ1=LvαG+LvαG−Lvα(GH)−Lvα(GL);
Δ2=LvβG+LvβG−Lvβ(GH)−Lvβ(GL);
y2=Δ1²+Δ2²;
where y2 takes a minimum value, values of LvαG and LvβG are obtained by lookup from the relation curves G−LvαG and G−LvβG, values of Lvα(GH) and Lvα(GL) are obtained by lookup from the relation curve G₀−LvαG₀, and values of Lvβ(GH) and Lvβ(GL) are obtained by lookup from the relation curve G₀−LvβG₀;
S205, for each grayscale value G of green sub-pixel required by the display unit, obtaining a corresponding combination of grayscale values GH and GL according to the step S204 and thereby re-building a display lookup table for the green sub-pixels of the liquid crystal panel.

14. The liquid crystal panel according to claim 13, wherein the front viewing angle α is 0°, and the oblique viewing angle β is 30°˜80°.

15. The liquid crystal panel according to claim 14, wherein the oblique viewing angle β is 60°.

16. The liquid crystal panel according to claim 11, wherein each of the plurality of pixel units further comprises a red sub-pixel, and a data signal for the red sub-pixel remains unchanged when re-setting data parameters for the blue sub-pixel and the green sub-pixel.

17. The liquid crystal panel according to claim 11, wherein grayscales of the liquid crystal panel comprises 256 levels of 0˜255.

18. The driving method according to claim 11, wherein in the predetermined Gamma (γ) curve, γ=2.2.

19. The driving method according to claim 13, wherein in the predetermined Gamma (γ) curve, γ=2.2.
